(19) United States
(12) Patent Application Publication
(10) Pub. No.: US 2025/0262786 A1
(43) Pub. Date: Aug. 21, 2025

(54) FOOD PRODUCT SLICER AND ASSOCIATED GAUGE PLATE PLANE ADJUSTMENT ASSEMBLY

(71) Applicant: ILLINOIS TOOL WORKS INC., Glenview, IL (US)

(72) Inventors: Matthew W. BIRD, Xenia, OH (US); Austin RUTLEDGE, Troy, OH (US); Curtis SMITH, Troy, OH (US)

(21) Appl. No.: 19/048,272

(22) Filed: Feb. 7, 2025

Related U.S. Application Data
(60) Provisional application No. 63/555,679, filed on Feb. 20, 2024.

(51) Int. Cl. B26D 7/01; B26D 7/22

(52) U.S. Cl. CPC B26D 7/01; B26D 7/225; B26D 2210/02

(57) ABSTRACT

A food product slicer includes a base, a knife mounted for rotation relative to the base and a carriage assembly mounted to the base for movement back and forth past a cutting edge of the knife. A gauge plate is mounted for movement between a closed position that prevents slicing and multiple open positions that permit slicing at respective thicknesses. A gauge plate movement system is provided for moving the gauge plate between the closed position and the multiple open positions. The gauge plate movement system includes a movable index component having a portion that projects upwardly through an opening in the base and that is connected to a lower portion of the gauge plate by a gauge plate adjustment assembly that is accessible via a gap between an upper surface portion of the base and the lower portion of the gauge plate.

### TECHNICAL FIELD

This application relates generally to food product slicers of the type commonly used to slice bulk food products and, more specifically, to a gauge plate plane adjustment assembly in such a food product slicer.

### BACKGROUND

Typical reciprocating food slicers have a rotatable, circular or disc-like slicing blade, an adjustable gauge plate for varying the thickness of the slice and a carriage for supporting the food as it is moved back and forth past the cutting edge of the knife during slicing. A drive motor may be linked to drive the carriage back and forth during an automatic slicing operation carried out by a controller of the slicer. The gauge plate is situated along the edge of the knife toward the front of a slicing stroke and is movable with respect to the knife for varying the thickness of the slices to be cut. A rotatable indexing knob is provided for manually setting a spacing between the plane of the gauge plate surface and the plane of the knife edge for the purpose of slicing so that operators can select a thickness of slices to be produced. Properly locating an edge of the gauge plate at a desired distance from the slicer knife and/or aligning, or substantially aligning, the plane of the gauge plate slide surface with the plane of the knife edge has presented challenges.

U.S. Pat. No. 5,970,840 discloses a gauge plate adjustment assembly in which four set screws act as the adjustment set screws for defining the gauge plate orientation. To adjust the plane of the gauge plate, the clamping screws or bolts are first loosened. The gauge plate can then be shifted around, and the set screws can adjust the relative height at each location. Once the position of the gauge plate is correct, the clamping screws or bolts can then be tightened. In practice, 4 set screws over-define the adjustment/assembly (i.e., only 3 set screws can possibly touch the gauge plate at one time—one will always be not touching the gauge plate), and the entire set up may shift when the clamping screws or bolts are tightened. This arrangement also allows for many degrees of freedom. The gauge plate can shift left/right, up/down, and twist a bit relative to these directions. The set screws also allow the gauge plate to rotate in 2 different directions. U.S. Pat. No. 7,832,317 discloses a gauge plate adjustment system that is above the slicer, but connects to an upper portion at the back side of gauge plate. This adjustment system was not very robust and, thus, proved to be less effective than desired.

Accordingly, it would be desirable to provide a slicer with an improved gauge plate assembly that is robust, yet simple and intuitive.

### SUMMARY

In one aspect, a food product slicer includes a base, a knife mounted for rotation relative to the base and a carriage assembly mounted to the base for movement back and forth past a cutting edge of the knife. A gauge plate is mounted for movement between a closed position that prevents slicing and multiple open positions that permit slicing at respective thicknesses. A gauge plate movement system is provided for moving the gauge plate between the closed position and the multiple open positions. The gauge plate movement system includes a movable index component having a portion that projects upwardly through an opening in the base and that is connected to a lower portion of the gauge plate by a gauge plate adjustment assembly that is accessible via a gap between an upper surface portion of the base and the lower portion of the gauge plate.

In implementations of the foregoing aspect, the slicer includes a seal assembly between the opening in the base and the lower portion of the gauge plate, wherein the gauge plate adjustment assembly is surrounded by the seal assembly such that the seal assembly must be moved out of a sealing position to provide access to the gauge plate adjustment assembly to enable gauge plate adjustment via the gauge plate adjustment assembly.

In implementations of the foregoing aspect, the gauge plate adjustment assembly includes a first set of fasteners by which a gauge plate plane of the gauge plate can be adjusted about a rotational degree of freedom and a second set of fasteners by which the gauge plate can be adjusted along a linear degree of freedom, wherein the first set of fasteners and the second set of fasteners are located in an upper region of the gap.

In implementations of the foregoing aspect, the gauge plate adjustment assembly includes an adjustment block connected to the gauge plate by first fasteners, each of the first fasteners passing through respective elongated slots on the adjustment block and engaged in threaded openings of the lower portion of the gauge plate such that, when the fasteners are in a loosened condition, movement of the adjustment block linearly relative to the fasteners provides a translational degree of freedom for adjustment of the gauge plate.

In implementations of the foregoing aspect, the adjustment block includes an upwardly facing recess, a clamp nut positioned in the recess of the adjustment block, second fasteners that connect the clamp nut to the movable index component, and third fasteners that position the adjustment block relative to the clamp nut, wherein adjustment of the third fasteners enables a pivoting movement of the adjustment block relative to the clamp nut to provide a rotational degree of freedom for adjustment of the gauge plate.

In implementations of the foregoing aspect, wherein the second fasteners pass through slots of the adjustment block to engage the clamp nut.

In implementations of the foregoing aspect, at least one mating rib and slot feature is provided between the adjustment block and the portion of the movable index component.

In implementations of the foregoing aspect, wherein the adjustment block includes multiple elongated ribs, the lower portion of the gauge plate include multiple elongated slots, each of the elongate ribs seated within a respective one of the elongated slots, wherein a length of each elongated rib is shorter than a length of the respective one of the elongated slots in which the elongated rib is seated.

In another aspect, a food product slicer includes a base, a knife mounted for rotation relative to the base and a carriage assembly mounted to the base for movement back and forth past a cutting edge of the knife. A gauge plate is mounted for movement between a closed position that prevents slicing and multiple open positions that permit slicing at respective thicknesses. A gauge plate movement system is provided for moving the gauge plate between the closed position and the multiple open positions, the gauge plate movement system including a movable index component. A gauge plate adjustment assembly interconnects the movable index component to the gauge plate, wherein the gauge plate adjustment assembly includes a first set of fasteners by which a gauge plate plane of the gauge plate can be adjusted about a rotational degree of freedom and a second set of fasteners by which the gauge plate can be adjusted along a linear degree of freedom, wherein the first set of fasteners and the second set of fasteners are located internally of a seal assembly that includes a first end sealed against the base and a second end sealed against the gauge plate.

In a further aspect, a food product slicer includes a base, a knife mounted for rotation relative to the base and a carriage assembly mounted to the base for movement back and forth past a cutting edge of the knife. A gauge plate is mounted for movement between a closed position that prevents slicing and multiple open positions that permit slicing at respective thicknesses, the gauge plate including a main body defining a food slide surface, and a foot portion extending from the main body. A gauge plate movement system is provided for moving the gauge plate between the closed position and the multiple open positions, the gauge plate movement system including a movable index component that is connected to the foot portion by a gauge plate adjustment assembly that includes: an adjustment block connected to the foot portion, the adjustment block having a recess; and a clamp nut positioned in the recess and at least one fastener connecting the clamp nut to the movable index component, wherein an orientation of the adjustment block, and thus the gauge plate, relative to the clamp nut is adjustable by set screws that are engaged in threaded openings of the adjustment block and that contact side portions of the clamp nut.

The details of one or more embodiments are set forth in the accompanying drawings and the description below. Other features, objects, and advantages will be apparent from the description and drawings, and from the claims.

### BRIEF DESCRIPTION OF DRAWINGS

FIGS. 1 and 2 show a food product slicer;

FIGS. 3-6 show views of gauge plate mount and gauge plate adjustment assembly;

FIGS. 7-10 show portions of the gauge plate adjustment assembly;

FIGS. 11-12 show portions of the gauge plate adjustment assembly connected to the gauge plate;

FIG. 13 shows a cross-section view of the gauge plate adjustment assembly;

FIGS. 14 and 15 show partial right side views and front side views of the slicer;

FIG. 16 shows a cross-section view of the slicer through the gauge plate adjustment assembly; and

FIG. 17 shows a partial perspective view of the slicer with seal removed.

### DETAILED DESCRIPTION

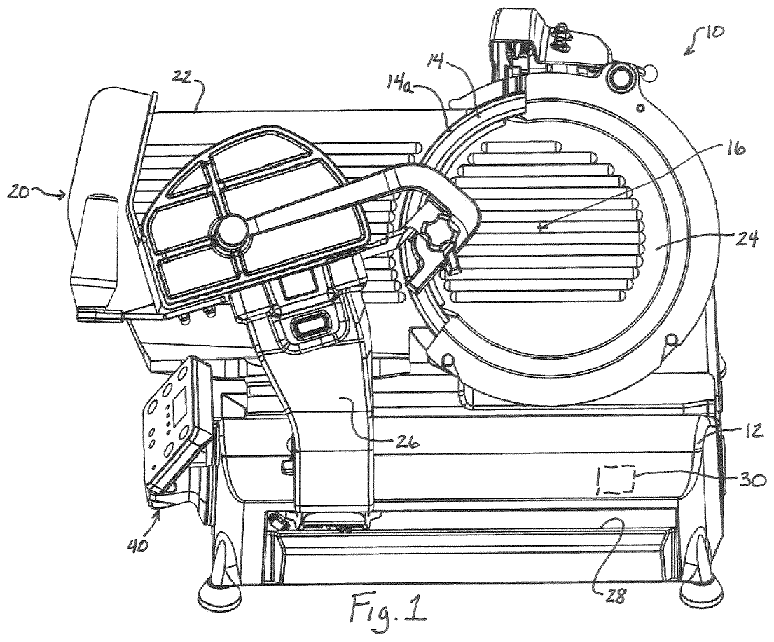

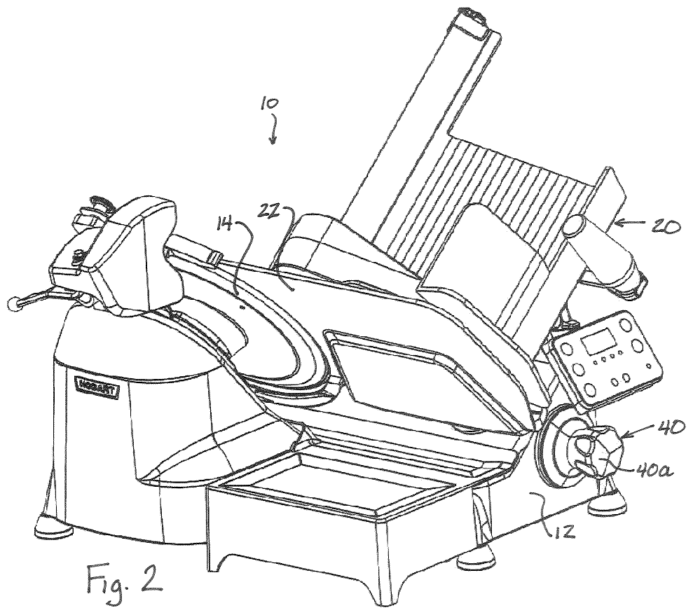

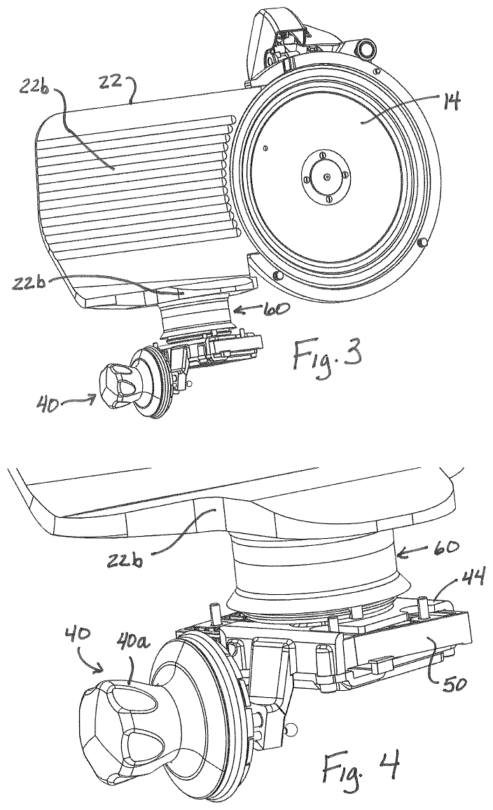

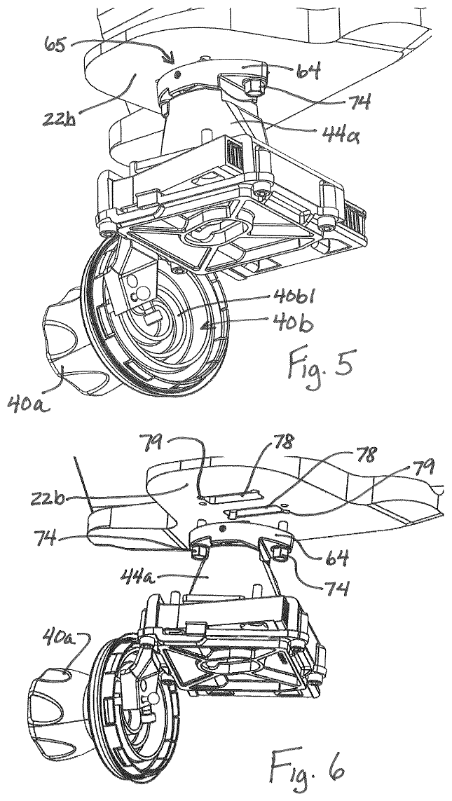

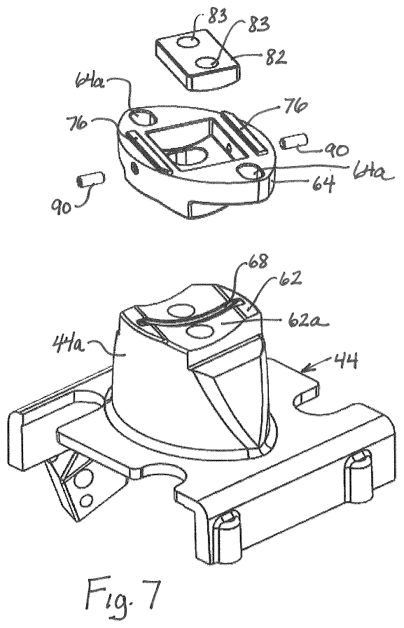

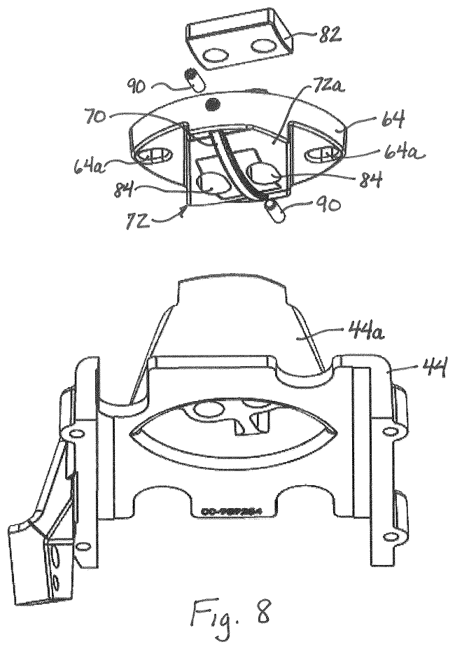

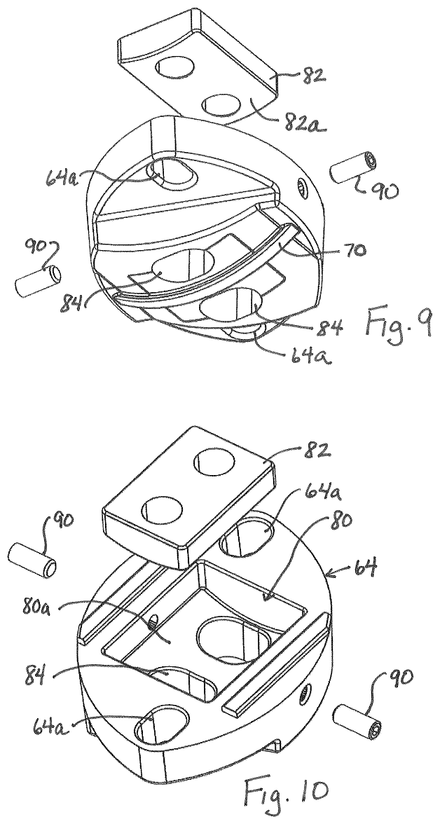

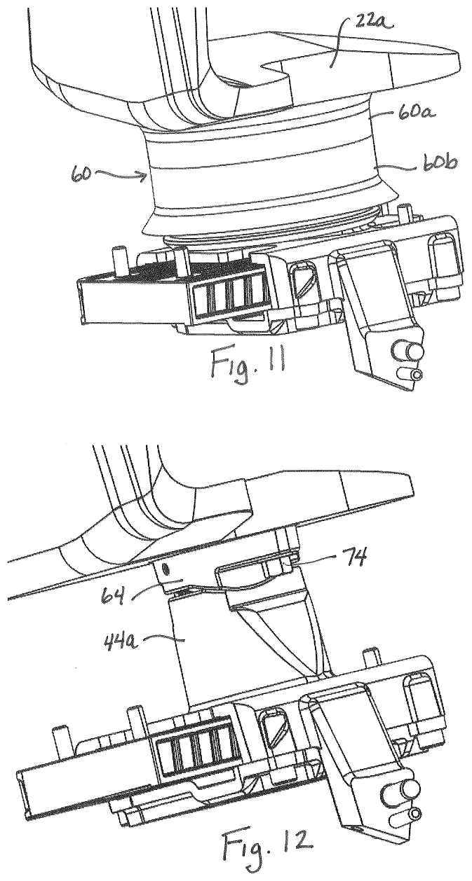

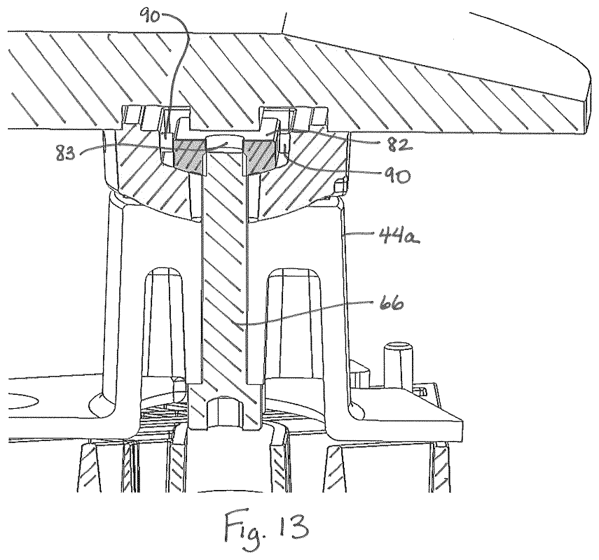

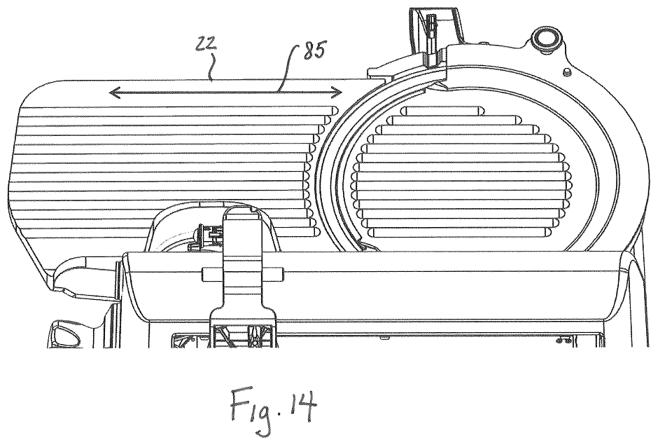

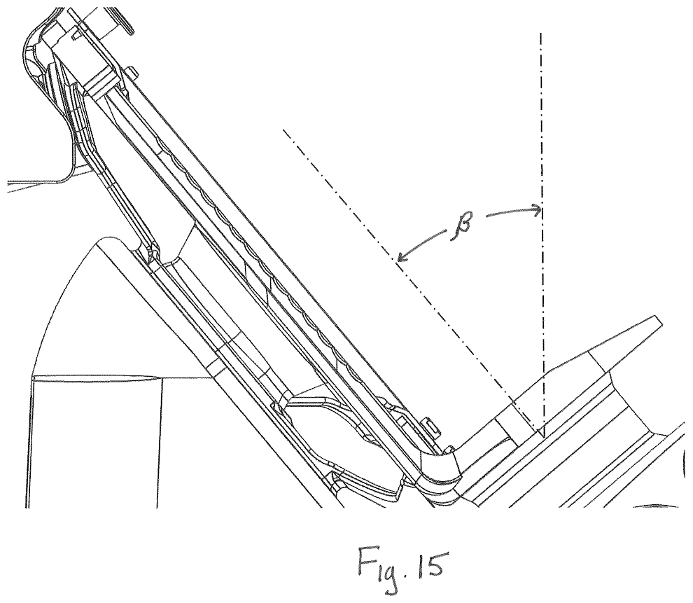

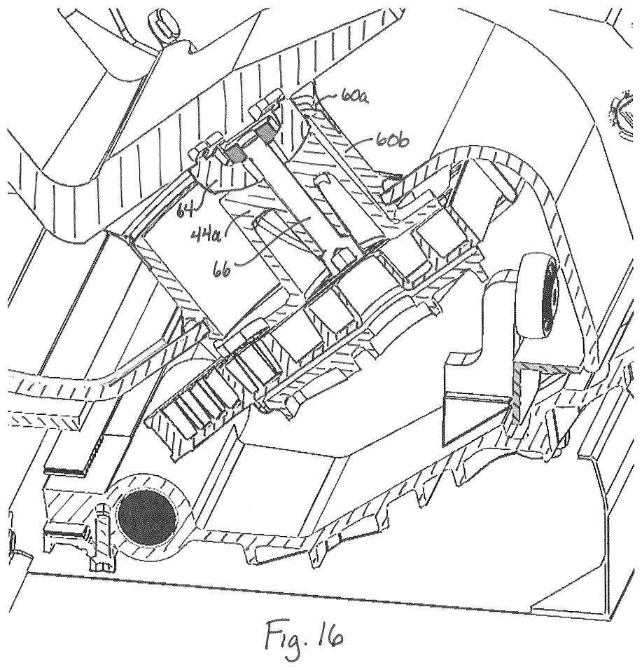

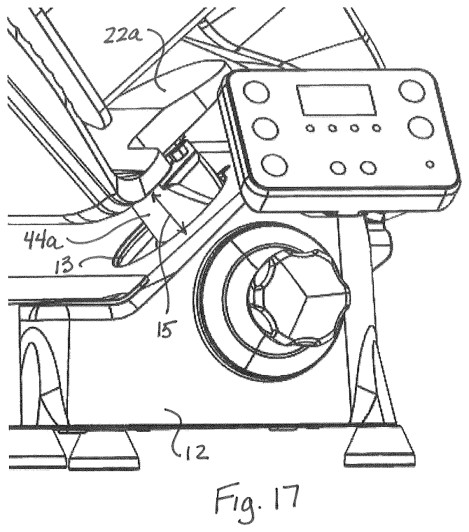

Referring to FIGS. 1-2, a food product slicer 10 includes a base 12 (e.g., housing and/or frame) and a circular, motor-driven slicing knife 14 that is mounted to the base for rotation about an axis 16. The left side of FIG. 1, where the controls are located, is generally referred to as the front side of the slicer (which is where an operator stands for slicing), the right side of FIG. 2 is generally referred to as the rear side of the slicer. A food product can be supported on a manually operable (or motor driven) food carriage 20 which moves the food product to be sliced past the peripheral cutting edge 14a of the rotating slicing knife 14. The food carriage 20 reciprocates from left to right relative to FIG. 2, along a linear carriage path so that the lower end of the bulk food product slides along the surface of a gauge plate 22, is cut by the knife 14 and then slides along a knife cover plate 24. Food carriage 20 includes a tray mounted on a tray arm 26 that orients the food carriage tray at the appropriate angle (typically perpendicular) to the knife cutting-edge plane. The food carriage arm reciprocates in a slot 28 at a lower portion of the base 12. The carriage 20 can be moved manually (e.g., by a handle) and/or the carriage 20 may also be automatically driven (e.g., as by an internal motor 30 that drives a belt that is linked internally to the arm 26).

The gauge plate 22 includes a main body plate 22b and a lower foot portion 22a extending from the main body plate.

A gauge plate positioning system includes a rotatable knob 40 (connected to an opening in the base 12) that includes a grip part 40a and a cam part 40b. The cam part 40b includes an axially facing spiral cam slot 40b1 that receives a follower pin 42 of a follower 44 that is part of an assembly 46 that is linked to move the gauge plate.

The follower 44 (aka index slider) is clamped to and rides on a slide rail 50 that is mounted in a fixed position within the base. An engagement of the follower 44 with the slide rail 50 is configured to allow sliding movement of the follower along an axis 52 of the slide rail while preventing rotation of the follower about the axis of the slide rail. An upwardly projecting portion 44a of the follower provides a location to which the gauge plate is attachable. In use, the portion 44a is surrounded by a gasket/seal 60.

An upper surface 62 of portion 44a of the follower receives an adjustment block 64. The upper surface 62 includes a concave arcuate curvature portion 62a and slot 68 that corresponds to a convex arcuate curvature 72a and rib 70 at the bottom surface 72 of the block 64. The rib 70 seats within the slot 68 and prevents small twisting/slop between the adjustment block 64 and the follower 44. The adjustment block 64 is connected to the underside of the gauge plate 24 (e.g., via fasteners 74 that pass through slots 64a of the adjustment block 64). The upper side of the adjustment block 64 includes rib features 76 that seat into and mate with slots 78 in a foot portion 22a of the gauge plate 22 to ensure the gauge plate cannot rotate relative to the adjustment block 64, but allows for some sliding movement along the slots (e.g., when the fasteners 74 are loosened), providing a linear degree of freedom in the adjustment system (toward or away from the knife edge per 85).

A recess 80 at the upper side of the adjustment block 64 holds a clamp nut 82 by fasteners 66 that pass through slots 84 in the block 64 and threadedly engage openings 83 of the clamp nut 82 to clamp the position of the adjustment block 64 onto portion 44a of the indexing component when the fasteners are tightened. The recess 80 defines a concave arcuate surface portion 80a that mates with a convex arcuate surface portion 82a at the bottom side of the clamp nut 82.

The clamp nut 82 is held in position relative to the adjustment block 64 via set screws/bolts 90, which when adjusted allow for some rotation and sliding of the clamp nut 82 relative to the adjustment block 64. The adjustment set screws 90 can be used to push the clamp nut 82 relative to the adjustment block 64, providing a rotational degree of freedom (e.g., per angle β). The design gives the operator significant control over the exact angle position of the gauge plate plane relative to the slicer knife plane.

The entire system can be adjusted “above the slicer” (e.g., without accessing the space internal of the base 12, such as by temporarily pushing the gasket 60 downward to access the fasteners 74 and the set screws 90). In one embodiment, the gasket 60 is a unitary piece capable of sufficient movement (e.g., a bellows style gasket/seal). In another embodiment, the gasket 60 is formed by a stiffer lower component 60b and a more flexible upper component 60a that is movable relative to the lower component 60b (e.g., component 60a movable downward relative to component 60b) to enable operator access to the screws 74 and the screws 90.

The gauge plate can be set and then tightened in two operations. This allows for the operator to adjust the gauge plate while being able to see the gauge plate relative to the knife. Most other adjustment methods occur underneath the slicer and require the slicer to be put up on its side. This design allows for only two degrees of freedom, which greatly simplifies what the operator needs to adjust.

The described design is very operator intuitive. There are only two adjustable degrees of freedom. One set of fasteners provides adjustment of a linear degree of freedom, and another set of fasteners provides adjustment of a rotational degree of freedom, enabling independent adjustment of the two degrees of freedom.

Thus, in the described embodiment, a food product slicer 10 includes a base 12, a knife 14 mounted for rotation relative to the base and a carriage assembly 20 mounted to the base for movement back and forth past a cutting edge 14a of the knife. A gauge plate 22 is mounted for movement between a closed position that prevents slicing and multiple open positions that permit slicing at respective thicknesses. A gauge plate movement system (e.g., knob 40 connected to move index component 44) is provided for moving the gauge plate between the closed position and the multiple open positions. The gauge plate movement system includes a movable index component 44 having a portion 44a that projects upwardly through an opening 13 in the base 112 and that is connected to a lower portion 22a of the gauge plate by a gauge plate adjustment assembly 65 that is accessible via a gap 15 between an upper surface portion of the base and the lower portion of the gauge plate.

In implementations, the slicer includes a seal assembly 60 between the opening in the base and the lower portion 22a of the gauge plate, wherein the gauge plate adjustment assembly 65 is surrounded by the seal assembly 66 such that the seal assembly must be moved out of a sealing position to provide access to the gauge plate adjustment assembly 65 to enable gauge plate adjustment via the gauge plate adjustment assembly.

In implementations of the foregoing aspect, the gauge plate adjustment assembly 65 includes a first set of fasteners 90 by which a gauge plate plane of the gauge plate can be adjusted about a rotational degree of freedom (e.g., adjusting angle β) and a second set of fasteners 74 by which the gauge plate can be adjusted along a linear degree of freedom 85, wherein the first set of fasteners and the second set of fasteners are located in an upper region of the gap 15.

In implementations, the gauge plate adjustment assembly 65 includes an adjustment block 64 connected to the gauge plate by first fasteners 74, each of the first fasteners passing through respective elongated slots 64a on the adjustment block and engaged in threaded openings 79 of the lower portion 22a of the gauge plate such that, when the fasteners are in a loosened condition, movement of the adjustment block linearly relative to the fasteners provides a translational degree of freedom 85 for adjustment of the gauge plate.

In implementations, the adjustment block 64 includes an upwardly facing recess 80, a clamp nut 82 positioned in the recess of the adjustment block, second fasteners 66 that connect the clamp nut 82 to the movable index component 44, and third fasteners 90 that position the adjustment block 64 relative to the clamp nut 82, wherein adjustment of the third fasteners 90 enables a pivoting movement of the adjustment block relative to the clamp nut to provide a rotational degree of freedom for adjustment of the gauge plate (e.g., adjusting angle β).

In implementations, the second fasteners 66 pass through slots 84 of the adjustment block 64 to engage the clamp nut 82.

In implementations, at least one mating rib 70 and slot 68 feature is provided between the adjustment block and the portion of the movable index component.

In implementations, the adjustment block 64 includes multiple elongated ribs 76, the lower portion of the gauge plate include multiple elongated slots 78, each of the elongate ribs 76 seated within a respective one of the elongated slots 78, and a length of each elongated rib 76 is shorter than a length of the respective one of the elongated slots 78 in which the elongated rib is seated.

It is to be clearly understood that the above description is intended by way of illustration and example only and is not intended to be taken by way of limitation. Variations are possible.

1. A food product slicer, comprising:
a base;
a knife mounted for rotation relative to the base;
a carriage assembly mounted to the base for movement back and forth past a cutting edge of the knife;
a gauge plate mounted for movement between a closed position that prevents slicing and multiple open positions that permit slicing at respective thicknesses;
a gauge plate movement system for moving the gauge plate between the closed position and the multiple open positions, the gauge plate movement system including a movable index component having a portion that projects upwardly through an opening in the base and that is connected to a lower portion of the gauge plate by a gauge plate adjustment assembly that is accessible via a gap between an upper surface portion of the base and the lower portion of the gauge plate.

2. The food product slicer of claim 1, further comprising a seal assembly between the opening in the base and the lower portion of the gauge plate, wherein the gauge plate adjustment assembly is surrounded by the seal assembly such that the seal assembly must be moved out of a sealing position to provide access to the gauge plate adjustment assembly to enable gauge plate adjustment via the gauge plate adjustment assembly.

3. The food product slicer of claim 1, wherein the gauge plate adjustment assembly includes a first set of fasteners by which a gauge plate plane of the gauge plate can be adjusted about a rotational degree of freedom and a second set of fasteners by which the gauge plate can be adjusted along a linear degree of freedom, wherein the first set of fasteners and the second set of fasteners are located in an upper region of the gap.

4. The food product slicer of claim 1, wherein the gauge plate adjustment assembly includes an adjustment block connected to the gauge plate by first fasteners, each of the first fasteners passing through respective elongated slots on the adjustment block and engaged in threaded openings of the lower portion of the gauge plate such that, when the fasteners are in a loosened condition, movement of the adjustment block linearly relative to the fasteners provides a translational degree of freedom for adjustment of the gauge plate.

5. The food product slicer of claim 4, wherein the adjustment block includes an upwardly facing recess, a clamp nut positioned in the recess of the adjustment block, second fasteners that connect the clamp nut to the movable index component, and third fasteners that position the adjustment block relative to the clamp nut, wherein adjustment of the third fasteners enables a pivoting movement of the adjustment block relative to the clamp nut to provide a rotational degree of freedom for adjustment of the gauge plate.

6. The food product slicer of claim 5, wherein the second fasteners pass through slots of the adjustment block to engage the clamp nut.

7. The food product slicer of claim 5, wherein at least one mating rib and slot feature is provided between the adjustment block and the portion of the movable index component.

8. The food product slicer of claim 4, wherein the adjustment block includes multiple elongated ribs, the lower portion of the gauge plate include multiple elongated slots, each of the elongate ribs seated within a respective one of the elongated slots, wherein a length of each elongated rib is shorter than a length of the respective one of the elongated slots in which the elongated rib is seated.

9. A food product slicer, comprising:
a base;
a knife mounted for rotation relative to the base;
a carriage assembly mounted to the base for movement back and forth past a cutting edge of the knife;
a gauge plate mounted for movement between a closed position that prevents slicing and multiple open positions that permit slicing at respective thicknesses;
a gauge plate movement system for moving the gauge plate between the closed position and the multiple open positions, the gauge plate movement system including a movable index component;
a gauge plate adjustment assembly interconnecting the movable index component to the gauge plate, wherein the gauge plate adjustment assembly includes a first set of fasteners by which a gauge plate plane of the gauge plate can be adjusted about a rotational degree of freedom and a second set of fasteners by which the gauge plate can be adjusted along a linear degree of freedom, wherein the first set of fasteners and the second set of fasteners are located internally of a seal assembly that includes a first end sealed against the base and a second end sealed against the gauge plate.

10. The food product slicer of claim 9, wherein the seal assembly must be moved out of a sealing position to provide access to the first set of fasteners and the second set of fasteners.

11. A food product slicer, comprising:
a base;
a knife mounted for rotation relative to the base;
a carriage assembly mounted to the base for movement back and forth past a cutting edge of the knife;
a gauge plate mounted for movement between a closed position that prevents slicing and multiple open positions that permit slicing at respective thicknesses, the gauge plate including a main body defining a food slide surface, and a foot portion extending from the main body;
a gauge plate movement system for moving the gauge plate between the closed position and the multiple open positions, the gauge plate movement system including a movable index component that is connected to the foot portion by a gauge plate adjustment assembly that includes:
an adjustment block connected to the foot portion, the adjustment block having a recess;
a clamp nut positioned in the recess and at least one fastener connecting the clamp nut to the movable index component, wherein an orientation of the adjustment block, and thus the gauge plate, relative to the clamp nut is adjustable by set screws that are engaged in threaded openings of the adjustment block and that contact side portions of the clamp nut.

12. The food product slicer of claim 11, wherein the adjustment block, clamp nut and the set screws are located in a gap between an upper surface portion of the base and the bottom of the foot portion.

13. The food product slicer of claim 12, wherein a seal assembly is disposed in the gap to enclose that gauge plate adjustment assembly.

14. The food product slicer of claim 13, wherein the seal assembly must be moved out of a sealing position to provide access to the set screws.
